(19) United States
(12) Patent Application Publication
(10) Pub. No.: US 2022/0338253 A1
(43) Pub. Date: Oct. 20, 2022

(54) SYSTEMS AND METHODS OF ENHANCED MULTI-LINK OPERATION RESPONSIVE TO TRANSMISSION FAILURE

(71) Applicant: MediaTek Singapore Pte. Ltd., Singapore (SG)

(72) Inventors: Kai Ying Lu, San Jose, CA (US); Yongho Seok, San Jose, CA (US); James Chih-Shi Yee, San Jose, CA (US)

(21) Appl. No.: 17/719,069

(22) Filed: Apr. 12, 2022

Related U.S. Application Data
(60) Provisional application No. 63/175,073, filed on Apr. 15, 2021.

(51) Int. Cl. H04W 74/08; H04W 72/04; H04L 5/00

(52) U.S. Cl. CPC H04W 74/085; H04W 74/0866; H04W 72/0446; H04L 5/0053

(57) ABSTRACT

Embodiments of the present invention provide improved multi-link operation over for recovering from a transmission failure on a primary link. During synchronous transmission on the NSTR pair of links, a transmission failure of an MPDU may happen on either link of the NSTR pair of links. Error recovery can be performed when an AP MLD is operating on the NSTR pair of links. When a transmission failure is detected, error recovery can be performed, and the timing of a synchronous transmission on the other wireless link can be managed to advantageously avoid IDC interference and improve performance of the wireless network.

### CROSS-REFERENCE TO RELATED APPLICATIONS

This application claims the benefit of and priority to provisional patent application Ser. No. 63/175,073, Attorney Docket Number MUSI-21-0045PUS, with filing date Apr. 15, 2021, by Kai Ying Lu, et al., which is hereby incorporated by reference in its entirety.

### FIELD

Embodiments of the present invention generally relate to the field of wireless communications. More specifically, embodiments of the present invention relate to systems and methods for enhanced multi-link operation in a wireless network.

### BACKGROUND

Modern electronic devices typically send and receive data with other electronic devices wirelessly using Wi-Fi, and many of these electronic devices are “dual band” devices that include at least two wireless transceivers capable of operating in different frequency bands, e.g., 2.4 GHz, 5 GHz, and 6 GHz. In most cases, a wireless device will communicate over only a single band at a time. For example, older and low-power devices, e.g., battery powered devices, often operate on the 2.4 GHz band. Newer devices and devices that require greater bandwidth often operate on the 5 GHz band. The availability of the 6 GHz band is a recent advancement and can provide higher performance, lower latency, and faster data rates.

The use of a single band may not satisfy the bandwidth or latency needs of certain devices. Therefore, some developing approaches to wireless communication increase communication bandwidth by operating on multiple bands concurrently (technically called link aggregation or multi-link operation). Advantageously, multi-link operations can provide higher network throughput and improved network flexibility compared to traditional techniques for wireless communication.

Some multi-link devices (MLDs) that support multi-link operations are susceptible to in-device coexistence (IDC) interference when two or more links of the MLD are close to each other as a result of transmission power leaking between links. As a result of the interference, some MLDs cannot support simultaneous transmission and reception using multiple links, referred to as a non-simultaneous transmit and receive (NSTR) link set. Furthermore, some MLDs only support a secondary wireless link only when a primary wireless link is in use. In the case of transmission failure on the primary link, the use of the secondary link may degrade performance of the wireless network when the primary link is used to recover from the transmission failure.

What is needed is needed is an approach to multi-link operation where a secondary link is prevented from interfering with performance of the wireless network (e.g., by transmitting corrupt data) when recovering from a transmission failure on a primary link.

### SUMMARY

Accordingly, embodiments of the present invention provide improved multi-link operation over for recovering from a transmission failure on a primary link. During synchronous transmission on the NSTR pair of links, a transmission failure of an MPDU may happen on either link of the NSTR pair of links. Error recovery can be performed when an AP MLD is operating on the NSTR pair of links. When a transmission failure is detected, error recovery can be performed, and the timing of a synchronous transmission on the other wireless link can be managed to advantageously avoid IDC interference and improve performance of the wireless network.

According to one embodiment, a method of wireless data exchange in a wireless network is disclosed. The method includes transmitting a first physical layer protocol data unit (PPDU) on a first wireless link during a first transmission opportunity (TXOP) and a second PPDU on a second wireless link during a second TXOP, detecting a transmission failure on the first wireless link, and terminating the second TXOP in response to the detecting the transmission failure on the first wireless link.

According to some embodiments, the method includes, responsive to the detecting the transmission failure, performing a first backoff procedure on the first wireless link, and performing a second backoff procedure on the second wireless link using contention parameters of a prior backoff procedure performed on the second wireless link.

According to some embodiments, the method includes receiving a first acknowledgement on the second wireless link, and said detecting includes determining that a block acknowledgement was not received on the first wireless link.

According to some embodiments, the method includes setting to zero a transmit network allocation vector (TXNAV) timer for the TXOP associated with the second wireless link.

According to some embodiments, the first PPDU and the second PPDU include initial frame exchanges of the first TXOP and the second TXOP respectively.

According to some embodiments, the second wireless link is configured to initiate a PPDU transmission by an MLD as a TXOP holder only when performing another PPDU transmission by the MLD as a TXOP holder substantially contemporaneously on the first wireless link.

According to some embodiments, the first PPDU and the second PPDU include non-initial frame exchanges of the corresponding TXOP.

According to some embodiments, the method includes receiving an acknowledgment responsive to the transmitting the second PPDU on the second wireless link.

According to some embodiments, the method includes terminating the second TXOP after the receiving the acknowledgment on the second wireless link responsive to detecting the failure of the first PPDU on the first wireless link.

According to a different embodiment, a method of wireless data transmission in a wireless network is disclosed. The method includes transmitting a first non-initial PPDU over a first wireless link and transmitting a second non-initial PPDU over a second wireless link, determining that the transmitting a first non-initial PPDU over the first wireless link includes a transmission failure, receiving an acknowledgement responsive to the transmitting the second non-initial PPDU over the second wireless link, transmitting a third non-initial PPDU on the second wireless link subsequent to the receiving, and transmitting a fourth non-initial PPDU over the first wireless substantially contemporaneously with the transmitting the third non-initial PPDU.

According to some embodiments, the method includes transmitting the fourth non-initial PPDU on the first wireless link is subsequent to a backoff procedure responsive to the determining.

According to some embodiments, the method includes the transmitting the fourth non-initial PPDU over the first wireless link is subsequent to a PIFS idle period in response to a decoding error of the acknowledgement in response to the first non-initial PPDU.

According to another embodiment, a method of wireless data exchange in a wireless network is disclosed. The method includes transmitting a first physical layer protocol data unit (PPDU) over a first wireless link within a first TXOP and a second PPDU over a second wireless link within a second TXOP, determining that the transmitting the second PPDU over the second wireless link includes a transmission error, receiving an acknowledgement on the first wireless link responsive to the transmitting the first PPDU over a first wireless link within the first TXOP, and transmitting another PPDU within the first TXOP and subsequent to the determining.

According to some embodiments, the method includes terminating the second TXOP on the second wireless link responsive to the determining.

According to some embodiments, the method includes acquiring a new TXOP on the second wireless link within the remaining duration of the first TXOP on the first wireless link responsive to the determining.

According to some embodiments, the method includes performing a backoff procedure on the second wireless link, and transmitting a third PPDU on the second wireless link if the medium is idle subsequent to the performing the backoff procedure and subsequent to the receiving the most recent acknowledgment on the first wireless link.

According to some embodiments, the method includes determining a transmission failure of the second PPDU on the second wireless link and performing error recovery on the second wireless link.

According to some embodiments, the performing error recovery on the second wireless link includes performing a backoff procedure to gain priority the access to the medium without using priority interframe space (PIES) channel access on the second wireless link.

According to some embodiments, the method includes transmitting a third non-initial PPDU on the first wireless link and a fourth PPDU on the second wireless link substantially contemporaneously with performing a backoff procedure on the second wireless link.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a depiction of an exemplary synchronous uplink transmission between an NSTR AP MLD and an NSTR non-AP MLD performed using contention-based channel access on both the primary link and the secondary link.

FIG. 2 is a depiction of an exemplary synchronous transmission of a downlink TXOP with aligned transmission.

FIG. 3 is a depiction of an exemplary wireless transmission 300 of a downlink TXOP for synchronous transmissions when the primary link is busy.

FIG. 4a is a depiction of an exemplary synchronous transmission of a downlink TXOP initiated by an NSTR AP MLD including a transmission error occurring on the primary link according to embodiments of the present invention.

FIG. 4b is a depiction of an exemplary synchronous transmission of a downlink TXOP initiated by an NSTR AP MLD with a transmission error occurring on the secondary link according to embodiments of the present invention.

FIG. 5 is a depiction of an exemplary downlink synchronous transmission TXOP initiated by an NSTR AP MLD with a transmission error occurring on the primary link following an initial frame exchange according to embodiments of the present invention.

FIG. 6 is a depiction of an exemplary synchronous transmission of a downlink TXOP initiated by an NSTR AP MLD for recovering an existing TXOP on a primary link and terminating a TXOP on the secondary link according to embodiments of the present invention.

FIG. 7 is a depiction of an exemplary synchronous transmission of a downlink TXOP initiated by an NSTR AP MLD including performing a backoff recovery on the primary link according to embodiments of the present invention.

FIG. 8 is a depiction of an exemplary synchronous transmission of a downlink TXOP initiated by an NSTR AP MLD where a TXOP on the secondary link is terminated after a transmission failure on the primary link according to embodiments of the present invention.

FIG. 9 is a depiction of an exemplary synchronous transmission of a downlink TXOP initiated by an NSTR AP MLD where a TXOP on the secondary link is terminated after a non-initial frame exchange failure on the secondary link according to embodiments of the present invention.

FIG. 10 is a depiction of an exemplary synchronous transmission of a downlink TXOP initiated by an NSTR AP MLD where a non-initial frame exchange fails and error recovery is performed on the secondary link according to embodiments of the present invention.

FIG. 11 is a depiction of an exemplary synchronous transmission of a downlink TXOP initiated by an NSTR AP MLD where transmission on the primary link continues after a transmission error occurs on the secondary link according to embodiments of the present invention.

FIG. 12 is a flow chart depicting exemplary steps of a computer implemented process for transmitting data in a wireless network over multiple links of an NSTR MLD according to embodiments of the present invention.

FIG. 13 is a flow chart depicting exemplary steps of a computer implemented process for transmitting data in a wireless network over multiple links of an NSTR MLD responsive to a PHY-RXSTART.indication primitive according to embodiments of the present invention.

FIG. 14 is a flow chart depicting exemplary steps of a computer implemented process for transmitting data in a wireless network over multiple links of an NSTR MLD having a transmission failure on the secondary wireless channel according to embodiments of the present invention.

FIG. 15 is a block diagram depicting an exemplary computer system platform upon which embodiments of the present invention may be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

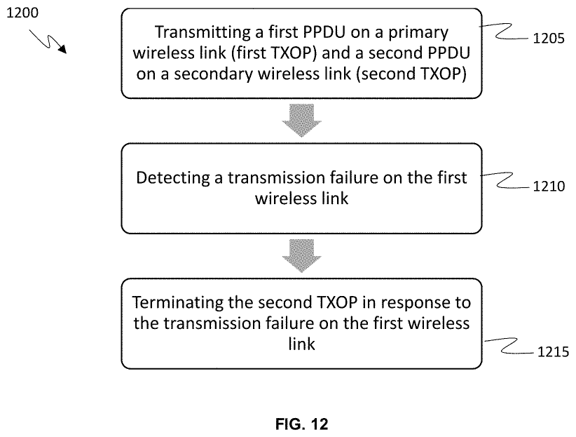

Portions of the detailed description that follow are presented and discussed in terms of a method. Although steps and sequencing thereof are disclosed in a figure herein (e.g., FIGS. 12-14) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Enhanced Multi-Link Operation

Embodiments of the present invention provide improved multi-link operation over for recovering from a transmission failure on a wireless link of an NSTR pair of links. During synchronous transmission on the NSTR pair of links, a transmission failure of an MPDU may happen on either link of the NSTR pair of links. Error recovery can be performed when an AP MLD is operating on the NSTR pair of links. According to some embodiments, when a transmission failure is detected on one of the wireless links, error recovery can be performed, and the timing of a synchronous transmission on the other wireless link can be managed to advantageously avoid IDC interference and improve performance of the wireless network.

When an AP MLD operates on an NSTR pair of links, synchronous transmission between an NSTR AP MLD and an STR/NSTR non-AP MLD can avoid IDC interference by performing contention-based channel access on the NSTR pair of links and begin transmission at the same time subject to several constraints. A primary link is designated for the NSTR pair of links, and another link is referred to as the secondary link (or non-primary link) of the NSTR pair of links. According to embodiments, the secondary link may initiate a PPDU transmission only if the STA affiliated with the same MLD in the primary link is also initiating the PPDU as a TXOP holder with substantially the same start time.

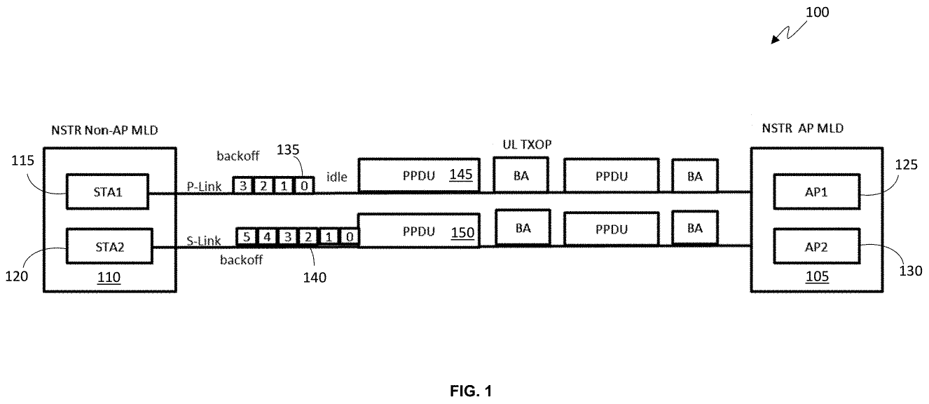

FIG. 1 depicts an exemplary synchronous uplink transmission 100 between an NSTR AP MLD 105 and an NSTR non-AP MLD 110 performed using contention-based channel access on both the primary link and the secondary link. The transmissions start at the same time when the TXOP initiator obtains medium access on both links. In the example of FIG. 1, STA1 115 and STA2 120 are affiliated with the same non-STR non-AP MLD 110 (TXOP initiator). AP1 125 and AP2 130 are affiliated with the same non-STR AP MLD 105 (TXOP responder). STA1 115 and STA2 120 start EDCA backoffs (e.g., random backoffs) 135 and 140 separately on the primary link and the secondary link.

When the random backoff (RBO) 135 of STA 1 115 counts down to zero first on the primary link, it may wait for the RBO 140 of STA 2 120 to count down to zero on the secondary link. Once the RBO 140 of STA 2 120 counts down to zero, STA1 115 and STA2 120 may transmit PPDUs 145 and 150 simultaneously if the primary link is idle based on virtual CS and physical CS. The end of PPDUs 145 and 150 on the primary and secondary link are aligned to avoid IDC interference. Moreover, the start of PPDU 145 on the waiting link (e.g., the primary link) is aligned with the start of PPDU 150 on the other link (e.g., the secondary link).

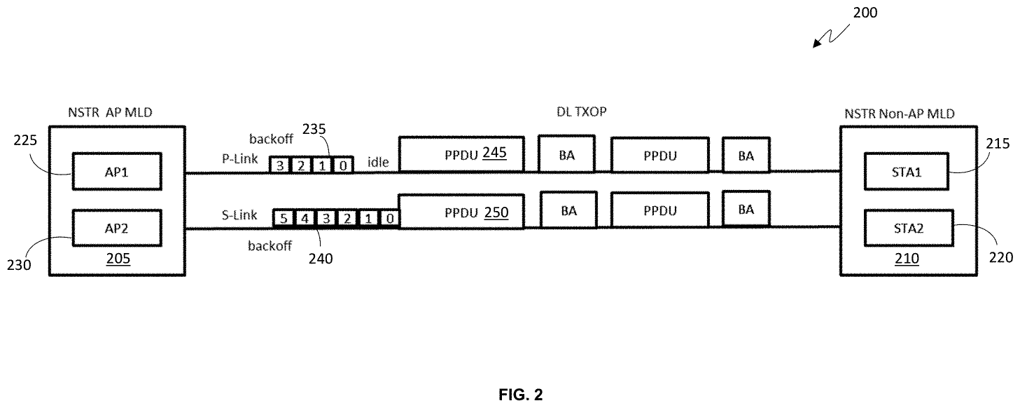

FIG. 2 depicts an exemplary synchronous transmission 200 of a downlink TXOP. AP1 225 and AP2 230 are affiliated with the same non-STR AP MLD 205 (TXOP initiator). STA1 215 and STA2 220 are affiliated with the same non-STR non-AP MLD 210 (TXOP responder). AP1 225 and AP2 230 perform EDCA backoff separately on the primary link and the secondary link. When AP1's RBO counts down to zero first on the primary link, it may wait for the RBO 240 of AP2 230 to count down to zero on the secondary link. Once the RBO 240 of AP2 230 count down to zero. If the primary link is idle based on virtual CS and physical CS, AP1 225 and AP2 230 may transmit PPDUs simultaneously. The end of PPDUs 245 and 250 on the primary and secondary link are aligned. The transmission of the PPDU 245 on the waiting link (e.g., the primary link) begins at substantially the same time as the start of PPDU 250 on the other link (e.g., the secondary link).

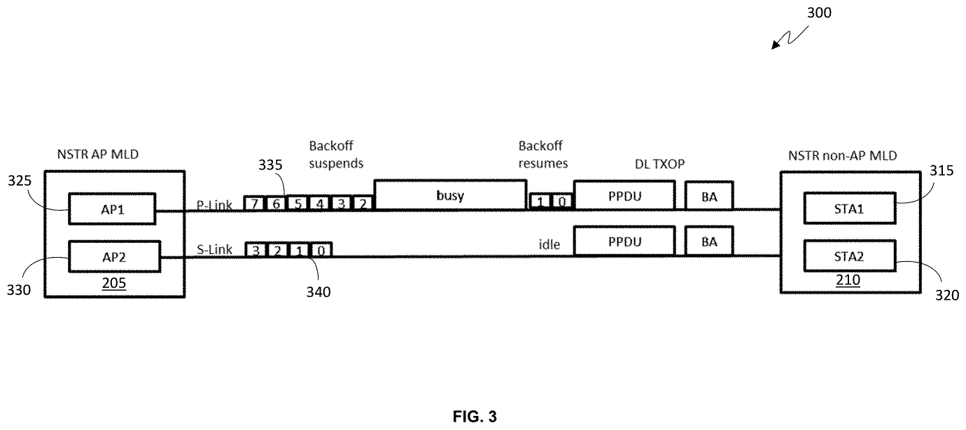

FIG. 3 depicts an exemplary wireless transmission 300 of a downlink TXOP for synchronous transmissions when the primary link is busy. AP1 325 and AP2 330 are affiliated with the same non-STR AP MLD 305 (TXOP initiator). STA1 315 and STA2 320 are affiliated with the same non-STR non-AP MLD 210 (TXOP responder). AP1 325 and AP2 330 perform EDCA backoffs 335 and 340 on the primary and secondary link separately. If the RBO 340 of AP2 330 counts down to zero first, it may wait for the RBO 335 of AP1 325 to count down to zero, or the backoff can be suspended when the channel becomes busy (e.g., overlapping basic service set (OBSS) busy, other system transmission). AP2 330 does not transmit on the secondary link when the primary link is busy.

### Enhanced Multi-Link Operation Error Recovery by a Multi-Link Device

A transmission failure of an MPDU transmitted during a multi-link operation may occur after transmitting an MPDU that requires an immediate response. In this case, the STA waits for a timeout interval of duration aSIFSTime+aSlotTime+aRxPHYStartDelay, the timeout interval starting when the MAC receives a primitive from the PHY layer (e.g., a “PHY-TXEND.confirm” primitive). If a “PHY-RXSTART.indication” primitive is not received during the timeout interval, the transmission of the 1VIPDU is considered a failure. If a “PHY-RXSTART.indication” primitive is received during the timeout interval, the STA waits for the corresponding “PHY-RXEND.indication” primitive to recognize a valid PPDU. If another frame is received (e.g., any other valid frame), the transmission of the 1VIPDU is considered a failure.

According to embodiments, the secondary link can initiate a PPDU transmission only if the STA affiliated with the same MLD in the primary link is also initiating the PPDU as a TXOP holder with the same start time. However, during synchronous transmission on the NSTR pair of links, a transmission failure of an MPDU may occur on either link of the NSTR pair of links. Error recovery can optionally be performed when an AP MLD is operating on the NSTR pair of links. According to some embodiments, a synchronous transmission on a secondary link is halted during error recovery on the primary link to advantageously avoid IDC interference and improve performance of the wireless network.

TXOP initiators affiliated with an NSTR AP MLD or an NSTR non-AP MLD can initiate frame exchanges to obtain TXOPs synchronously over an NSTR pair of links. When the MLD of the NSTR pair of links fails to obtain a TXOP on the primary link, it terminates the TXOP on the secondary link after a successful initial frame exchange on the secondary link, and the TXNAV timer of the TXOP initiator is reset to zero. Moreover, the MLD can perform a new backoff procedure, and the contention parameters (e.g., CW[AC] and QSRC[AC]) can be left unchanged. When a TXOP initiator of the MLD on the primary link of the NSTR pair of links successfully obtains the TXOP, and the other TXOP initiator of the same MLD on the secondary link of the NSTR pair of links fails to obtain the TXOP, the MLD may continue the frame exchange on the primary link and end channel access on the secondary link to wait for the termination of the TXOP on the primary link. It may also perform a new backoff procedure and initiate a new transmission on the secondary link which aligns with the start time of the transmission of a PPDU within the existing TXOP on the primary link.

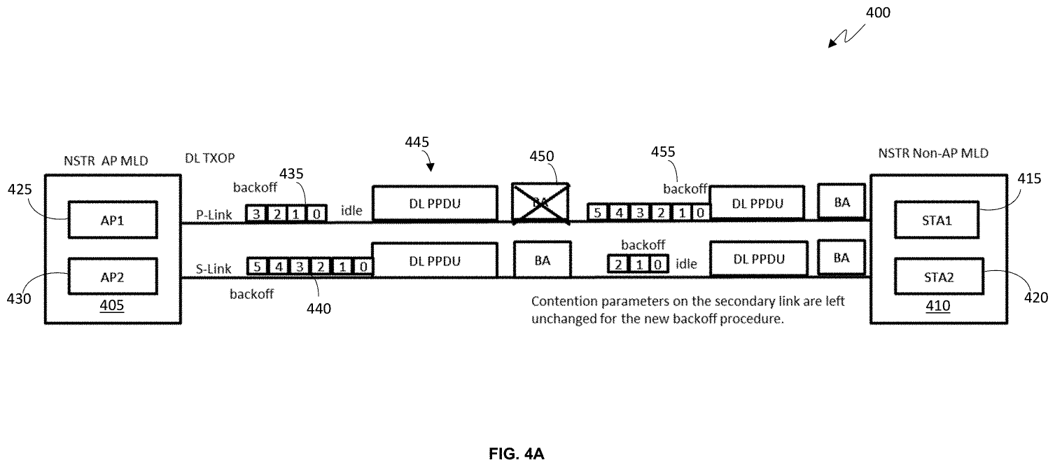

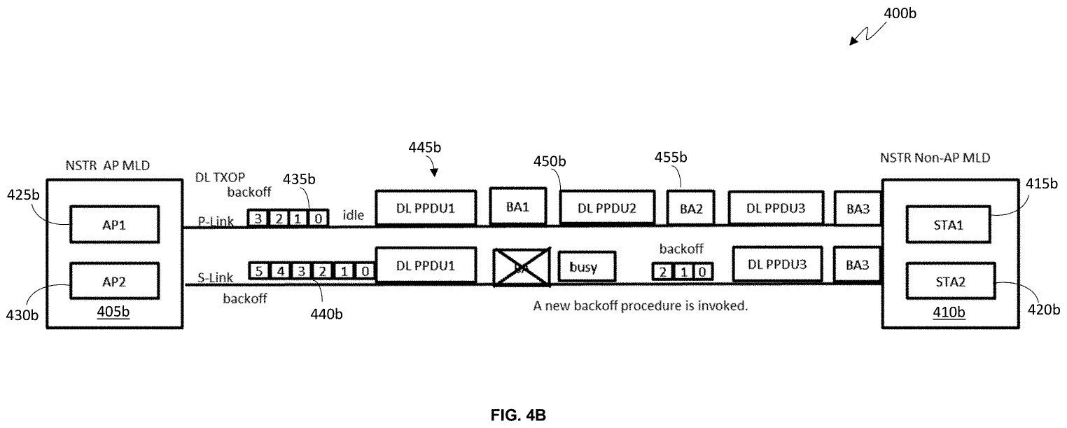

FIG. 4a depicts an exemplary synchronous transmission 400 of a downlink TXOP initiated by an NSTR AP MLD 405 including a transmission error occurring on the primary link according to embodiments of the present invention. AP1 425 and AP2 430 are affiliated with the same NSTR AP MLD 405 (TXOP initiators). STA1 415 and STA2 420 are affiliated with the same NSTR non-AP MLD 410 (TXOP responders). AP1 425 and AP2 430 perform EDCA backoffs 435 and 440 on the primary and secondary link separately. AP1 425 and AP2 430 initiate frame exchanges 445 on the primary and secondary link with the same start time when both EDCA backoff counters 435 and 440 on the primary and secondary link have reached zero. When the initial frame exchange of AP1 425 fails because a valid BA response 450 is not received on the primary link, AP2 430 terminates the TXOP after the successful initial frame exchange, and TXNAV timer of AP2 430 is reset to zero. AP2 430 may perform a new backoff 455 to initiate a new TXOP together with AP1 425 following the channel access rules of NSTR multilink operation. CW[AC] and QSRC[AC] are left unchanged on the secondary link. The initial frame exchanges 445 can include control frame exchange (e.g., RTS/CTS or MU-RTS/CTS).

FIG. 4b depicts an exemplary synchronous transmission of a downlink TXOP initiated by an NSTR AP MLD 405b with a transmission error occurring on the secondary link according to embodiments of the present invention. AP1 425b and AP2 430b are affiliated with the same NSTR AP MLD 405b (TXOP initiators). STA1 415b and STA2 420b are affiliated with the same NSTR non-AP MLD 410b (TXOP responders). AP1 425b and AP2 430b separately perform EDCA backoffs 435b and 440b on the primary and secondary link. AP1 425b and AP2 430b initiate frame exchanges 445b on the primary and secondary link with the same start time when both EDCA backoff counters 435b and 440b on the primary and secondary link have reached zero. When AP1 425b obtains a TXOP on the primary link, it continues the transmission within the TXOP regardless of the status of the secondary link.

When AP2 430b fails to obtain a TXOP due to the failure of initial frame exchange on the secondary link, AP2 430b may invoke a new backoff procedure and count down the backoff counter when the channel becomes idle and initiate a transmission that aligns with the start time of the next transmission from AP1 430b on the primary link within the existing TXOP. The new TXOP obtained by AP2 430b after the backoff procedure is within the duration of the existing TXOP of AP1 425 on the primary link.

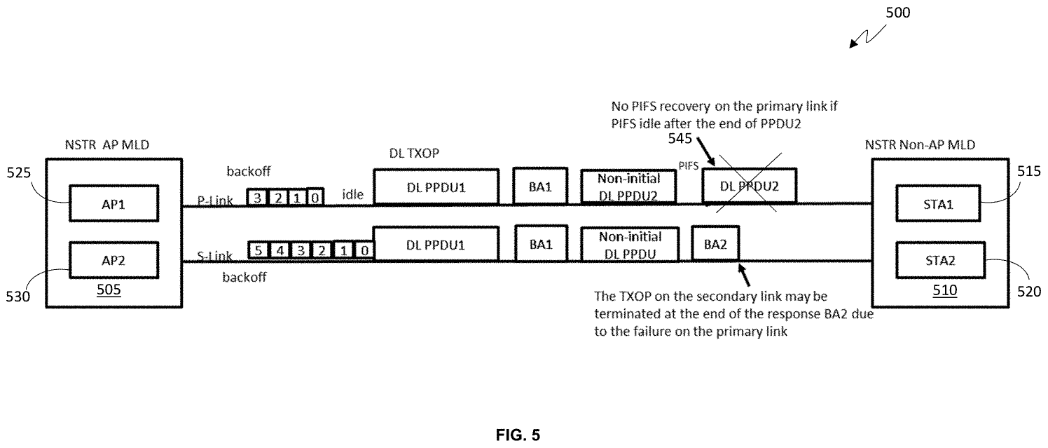

FIG. 5 depicts an exemplary synchronous transmission 500 of a downlink TXOP initiated by an NSTR AP MLD with a transmission error occurring on the primary link following an initial frame exchange according to embodiments of the present invention. AP1 525 and AP2 are affiliated with the same NSTR AP MLD (TXOP initiators). STA1 515 and STA2 520 are affiliated with the same NSTR non-AP MLD 510 (TXOP responders). In the example of FIG. 5, AP1 525 and AP2 530 obtain synchronous TXOPs on the primary and secondary link. A non-initial frame exchange (PPDU2+BA2) 545 of AP1 525 fails when a “PHY-RXSTART.indication” primitive (indicating a valid signal has been received) is not received or detected after the timeout interval on the primary link. AP1 525 does not perform PIFS recovery even though the channel is idle during the PIFS time interval after the end of PPDU2 545 on the primary link. AP2 530 terminates the TXOP on the secondary link after receiving BA2 due to the failure on the primary link without using priority interframe space (PIFS) channel access.

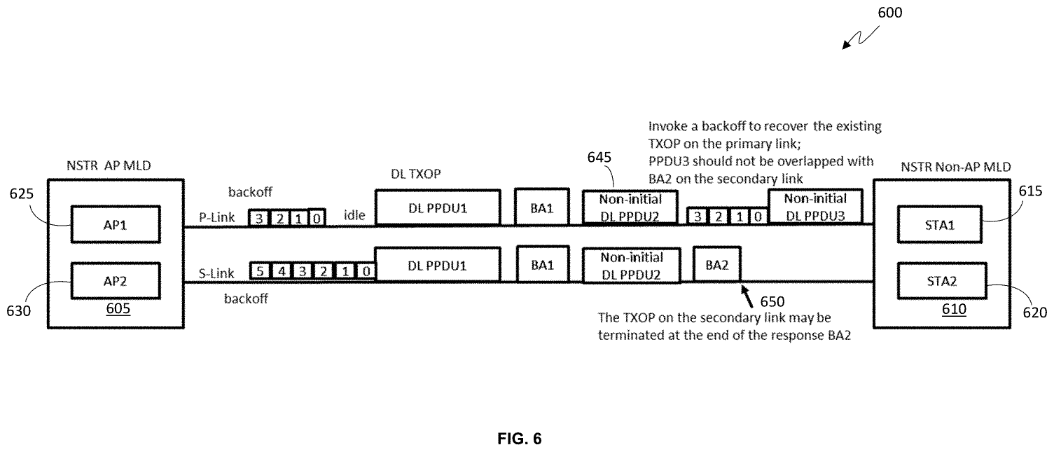

FIG. 6 shows an exemplary synchronous transmission 600 of a downlink TXOP initiated by an NSTR AP MLD 605 for recovering an existing TXOP on a primary link and terminating a TXOP on the secondary link according to embodiments of the present invention. AP1 625 and AP2 630 are affiliated with the same NSTR AP MLD 605 (TXOP initiators). STA1 615 and STA2 620 are affiliated with NSTR non-AP MLD (TXOP responders) 610. AP1 625 and AP2 630 obtain synchronous TXOPs on the primary and secondary link. A non-initial frame exchange (PPDU2+BA2) 645 fails when a “PHY-RXSTART.indication” primitive is not received or detected after the timeout interval PIFS on the primary link. AP1 625 may perform a backoff to recover the existing TXOP or to start a new TXOP. The transmission within the recovered TXOP or the new TXOP does not overlap with the response BA2 650 of the secondary link. AP2 630 may terminate the TXOP after receiving the response BA2 650 on the secondary link when it is unable to determine if the TXOP on the primary link is ongoing before performing the next frame exchange on the secondary link. The TXNAV NAV timer of AP2 630 may be reset to zero.

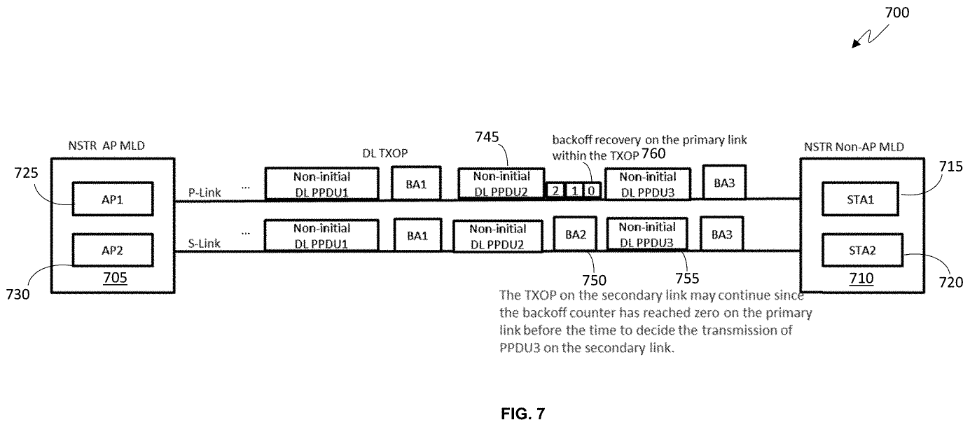

FIG. 7 depicts an exemplary synchronous transmission 700 of a downlink TXOP initiated by an NSTR AP MLD including performing a backoff recovery on the primary link according to embodiments of the present invention. AP1 725 and AP2 730 are affiliated with the same NSTR AP MLD 705 (TXOP initiators). STA1 715 and STA2 720 are affiliated with the same NSTR non-AP MLD 710 (TXOP responders). AP1 725 and AP2 730 obtain synchronous TXOPs on the primary and secondary link. A non-initial frame exchange (PPDU2+BA2) 745 of AP1 725 fails when a “PHY-RXSTART.indication” primitive is not received or detected after the timeout interval PIFS on the primary link. AP1 725 may perform a backoff 760 to recover the existing TXOP. The transmission 745 within the recovered TXOP does not overlap with the response frame BA2 750 on the secondary link. AP2 730 may continue the transmission of PPDU3 SIFS 755 after the valid response BA2 750 on the secondary link as AP1 725 continues the TXOP after backoff recovery 760 and before AP2 730 decides to transmit PPDU3 755 on the secondary link (e.g., backoff recovery 760 of AP1 725 is invoked when the transmission of PPDU2 745 fails and the backoff counter has reached zero). Otherwise, AP2 730 shall terminate the TXOP on the secondary link.

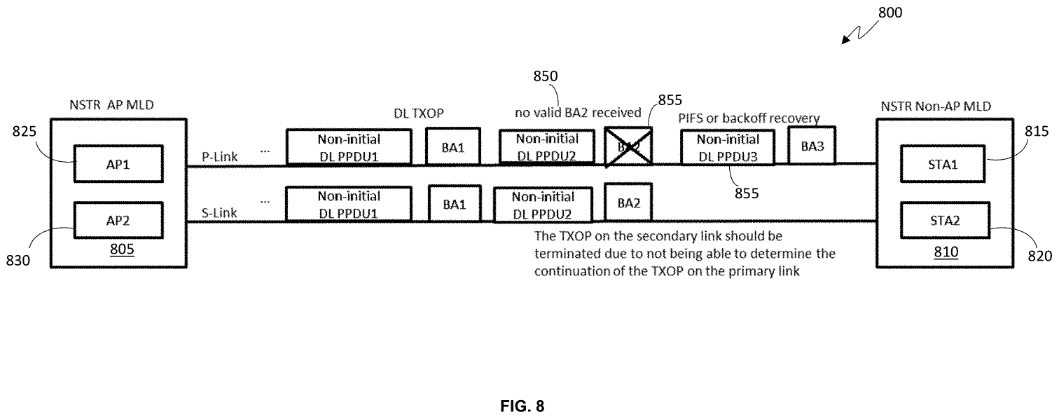

FIG. 8 depict an exemplary synchronous transmission 800 of a downlink TXOP initiated by an NSTR AP MLD 805 where a TXOP on the secondary link is terminated after a transmission failure on the primary link according to embodiments of the present invention. AP1 825 and AP2 830 are affiliated with the same NSTR AP MLD 805 (TXOP initiators). STA1 815 and STA2 820 are affiliated with the same NSTR non-AP MLD 810 (TXOP responders). AP1 825 and AP2 830 obtained synchronous TXOPs on the primary and secondary link. In the example of FIG. 8, AP1 825 does not recognize a valid response frame after the corresponding “PHY-RXEND.indication.” AP1 825 may perform a PIFS recovery or backoff recovery to continue the existing TXOP. AP2 830 cannot determine if the TXOP is ongoing on the primary link before is must decide to transmit or not transmit the following frame exchange on the secondary link and therefore terminates the TXOP.

When a TXOP initiator affiliated with an NSTR AP MLD or an NSTR non-AP MLD obtains synchronous TXOPs over an NSTR pair of links, and a TXOP holder of the MLD on the primary link of the NSTR pair of links receives a valid response frame to a non-initial frame, the TXOP holder can continue the transmission within the TXOP. The transmission can also be continued within the TXOP when the other TXOP holder of the same MLD on the secondary link of the NSTR pair of links fails to receive a valid response frame to a non-initial frame within the TXOP. For example, if a “PHY-RXSTART.indication” primitive is not received or detected during the timeout interval PIFS on the secondary link, the TXOP holder on the secondary link does not perform PIFS after the transmission of the non-initial frame, and can invoke a backoff.

If a “PHY-RXSTART.indication” primitive is received or detected during the timeout interval PIFS on the primary link, the TXOP holder on the secondary link waits for the corresponding “PHY-RXEND.indication” primitive to recognize a valid response frame. If it does not recognize a valid response frame, the TXOP holder on the secondary link does not perform PIFS recovery, and can invoke a backoff. The TXOP holder on the secondary link may continue the existing TXOP after invoking the backoff and initiate the (re)transmission within the existing TXOP aligning the start time of the transmission with the next transmission on the primary link when the medium is idle and the following conditions are met:
1) If the backoff counter of the TXOP holder reaches zero on a slot boundary of the secondary link;
2) if the backoff counter of the TXOP holder is already zero and the TXOP holder chooses to not transmit and keeps the backoff counter at zero.

The TXOP holder on the secondary link may also terminate the TXOP at any time due to a frame exchange failure on the secondary link, in which case the TXNAV timer of the TXOP holder may be reset to zero.

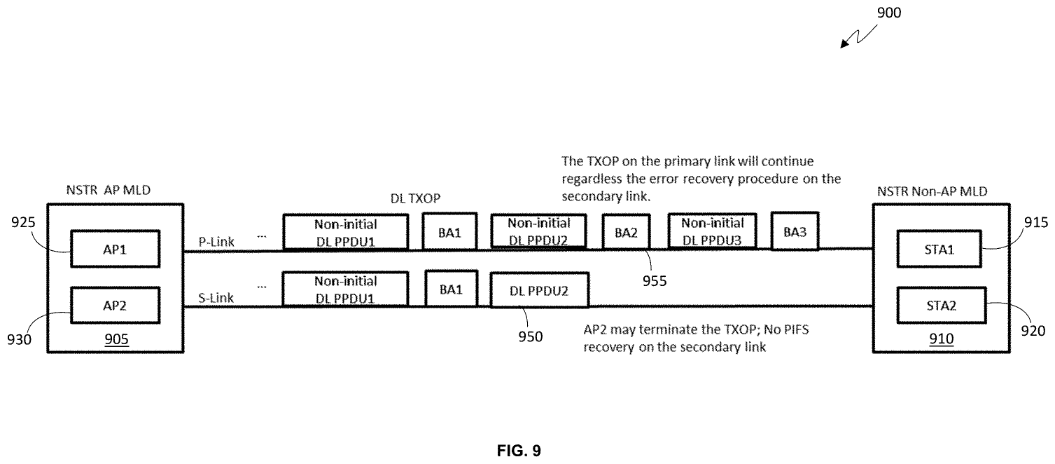

FIG. 9 depicts an exemplary synchronous transmission 900 of a downlink TXOP initiated by an NSTR AP MLD 905 where a non-initial frame exchange fails according to embodiments of the present invention. AP1 925 and AP2 930 are affiliated with the same NSTR AP MLD (TXOP initiators). STA1 915 and STA2 920 are affiliated with the same NSTR non-AP MLD 910 (TXOP responders). AP1 925 and AP2 930 obtained synchronous TXOPs on the primary and secondary link. A non-initial frame exchange (PPDU2+BA2) 950 of AP2 930 fails when a “PHY-RXSTART.indication” primitive is not received or detected after the timeout interval PIFS on the secondary link. AP1 925 may continue the existing TXOP regardless the error status on the secondary link. AP2 930 may terminate the TXOP without PIFS error recovery on the secondary link.

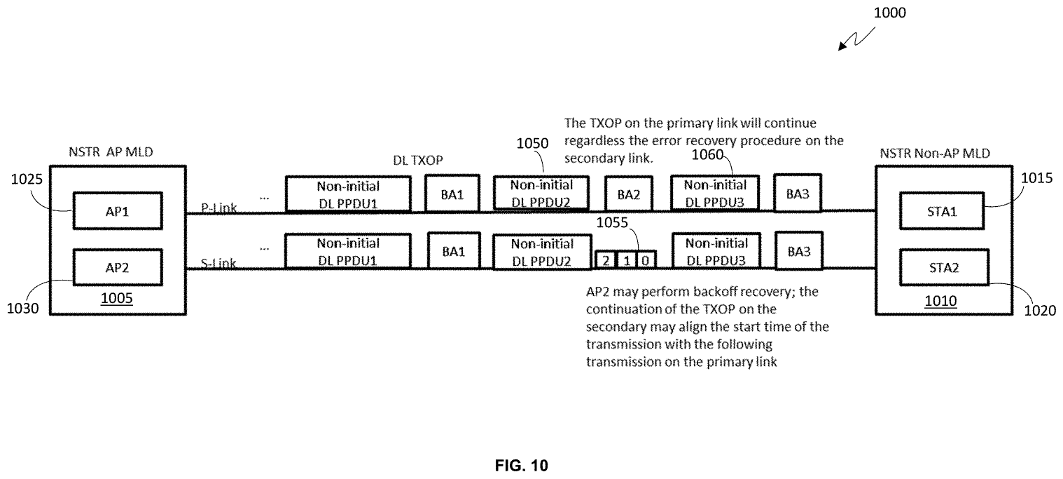

FIG. 10 depicts an exemplary synchronous transmission of a downlink TXOP initiated by an NSTR AP MLD 1005 where a non-initial frame exchange fails and error recovery is performed on the secondary link according to embodiments of the present invention. AP1 1025 and AP2 1030 are affiliated with the same NSTR AP MLD 1005 (TXOP initiators). STA1 1015 and STA2 1020 are affiliated with the same NSTR non-AP MLD 1010 (TXOP responders). In the example of FIG. 10, AP1 1025 and AP2 1030 obtain synchronous TXOPs on the primary and secondary link. A non-initial frame exchange 1050 (PPDU2+BA2) of AP2 1030 fails when a “PHY-RXSTART.indication” primitive is not received or detected after the timeout interval PIFS on the secondary link. AP1 1025 may continue the existing TXOP regardless the error status on the secondary link, and AP2 1030 may perform error recovery by invoking a backoff procedure 1055 and initiate the (re)transmission within the existing TXOP on the secondary link aligning with the start time of the transmission of PPDU3 1060 on the primary link when the medium is idle and one of the following conditions is met:
1. The backoff counter 1055 of AP2 1030 reaches zero on a slot boundary of the secondary link;
2. The backoff counter 1055 of AP2 1030 is already zero and AP2 1030 chooses to not transmit and keep the backoff counter at zero.

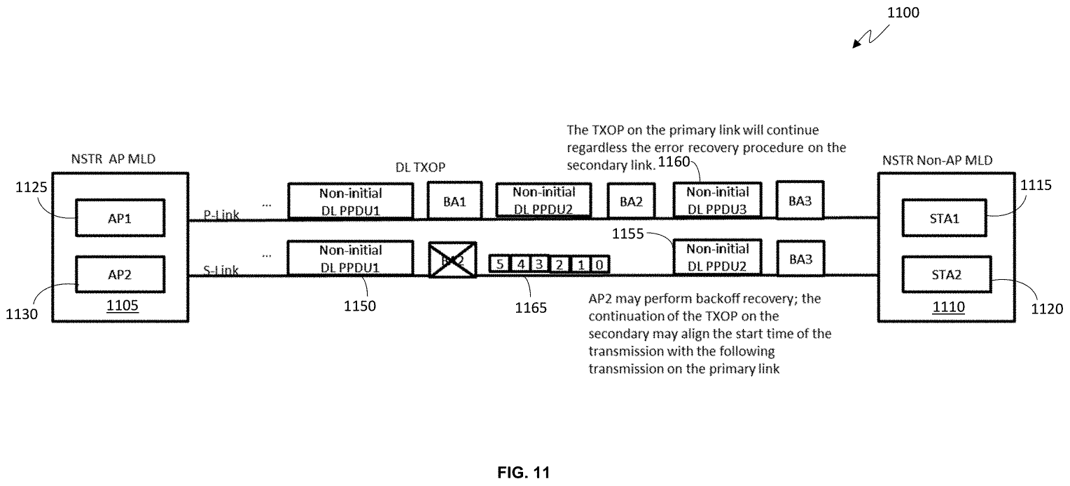

FIG. 11 depicts an exemplary synchronous transmission 1100 of a downlink TXOP initiated by an NSTR AP MLD where transmission on the primary link continues after a transmission error occurs on the secondary link according to embodiments of the present invention. AP1 1125 and AP2 1130 are affiliated with the same NSTR AP MLD 1105 (TXOP initiators). STA1 1115 and STA2 1120 are affiliated with the same NSTR non-AP MLD 1110 (TXOP responders). AP1 1125 and AP2 1130 obtained synchronous TXOPs on the primary and secondary link. In the example of FIG. 11, a non-initial frame exchange (PPDU1+BA1) 1150 of AP2 1130 fails when a “PHY-RXSTART.indication” is not received after the timeout interval PIFS and does not recognize a valid response frame on the secondary link. AP1 1125 may continue the existing TXOP regardless the error status on the secondary link, and AP2 1130 may terminate the TXOP. AP2 1130 may also perform error recovery by invoking a backoff procedure and initiate the (re)transmission of PPDU2 1155 within the existing TXOP on the secondary link aligning with the start time of the transmission of PPDU3 1160 on the primary link when the medium is idle and one of the following conditions is met:
1. The backoff counter 1165 of AP2 1130 reaches zero on a slot boundary of the secondary link;
2. The backoff counter 1165 of AP2 1130 is already zero and AP2 1130 chooses not to transmit and keep the backoff counter at zero.

FIG. 12 is a flow chart depicting exemplary program steps of a computer implemented process 1200 for transmitting data in a wireless network over multiple links of an NSTR MLD according to embodiments of the present invention.

At step 1205, a first PPDU is transmitted on a primary wireless link during a first TXOP and a second PPDU is transmitted on a secondary wireless link during a second TXOP.

At step 1210, a transmission failure is detected on the primary wireless link, for example, when a block acknowledgment is not received within a predetermined time period (timeout period) or when a “PHY-RXSTART.indication” primitive is not received.

At step 1215, the second TXOP is terminated responsive to the transmission failure on the first wireless link.

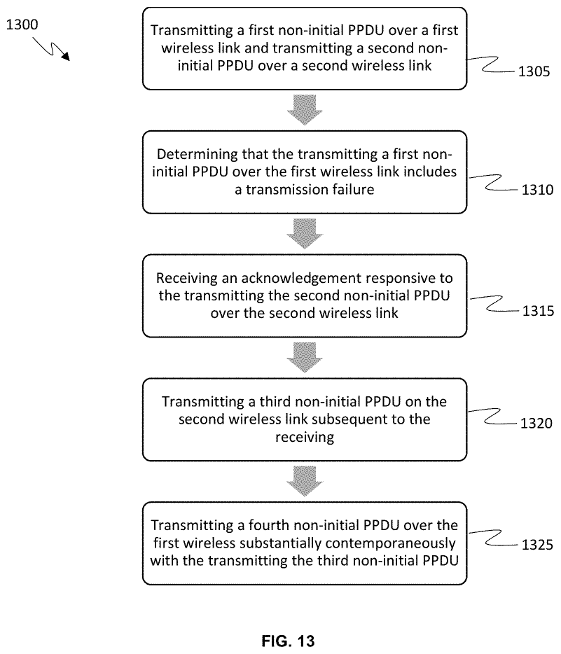

FIG. 13 is a flow chart depicting exemplary steps of a computer implemented process 1300 for transmitting data in a wireless network over multiple links of an NSTR MLD according to embodiments of the present invention.

At step 1305, a first non-initial PPDU is transmitted over a first wireless link (such as a primary wireless link) and a second non-initial PPDU is transmitted over a second wireless link (such as a secondary wireless link).

At step 1310, it is determined that transmitting the first non-initial PPDU transmitted over the first wireless link in step 1305 includes a transmission error.

At step 1315, an acknowledgement is received responsive to the transmitting the second non-initial PPDU over the second wireless link.

At step 1320, a third non-initial PPDU is transmitted on the second wireless link subsequent to the receiving.

At step 1325, a fourth non-initial PPDU is transmitted over the first wireless link substantially contemporaneously with the transmitting the third non-initial PPDU.

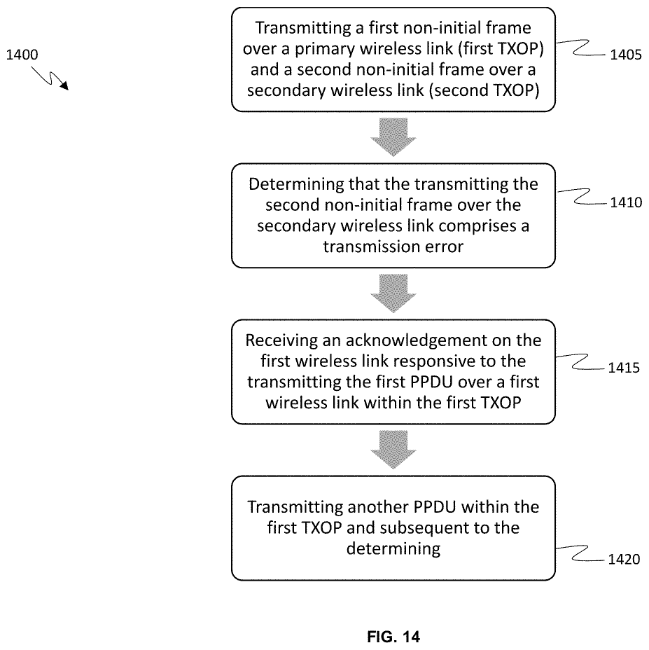

FIG. 14 is a flow chart depicting exemplary steps of a computer implemented process 1400 for transmitting data in a wireless network over multiple links of an NSTR MLD having a transmission failure on the secondary wireless channel according to embodiments of the present invention.

At step 1405, a first PPDU (can be an initial frame or a non-initial frame) is transmitted over a first wireless link (such as a primary wireless link) within a first TXOP and a second PPDU (can be an initial frame or a non-initial frame) over a second wireless link (such as a secondary wireless link).

At step 1410, it is determined that the transmitting the second non-initial frame over the second wireless link includes a transmission error.

At step 1415, a block acknowledgement is received on the first wireless link responsive to the transmitting the first PPDU over a first wireless link within the first TXOP.

At step 1420, another PPDU is transmitted within the first TXOP and subsequent to the determining in step 1410.

### Exemplary Computer Controlled System

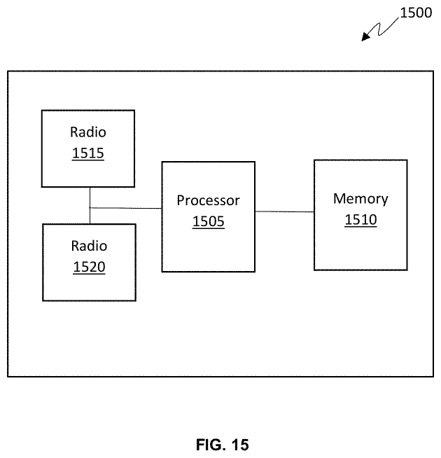

FIG. 15 depicts an exemplary wireless device 1500 upon which embodiments of the present invention can be implemented. Embodiments of the present invention are drawn to multi-link wireless devices that can recover from a transmission failure on a wireless link of an NSTR pair of links. During synchronous transmission on the NSTR pair of links, a transmission failure of an MPDU may happen on either link of the NSTR pair of links. Wireless device 1500 can detect a transmission failure and perform error recovery on one of the wireless links, and the timing of a synchronous transmission on the other wireless link can be managed to advantageously avoid IDC interference and improve performance of the wireless network.

Wireless device 1500 includes a processor 1505 for running software applications and optionally an operating system. Memory 1510 can include read-only memory and/or random access memory, for example, to store applications and data (e.g., tables of index values) for use by the processor 1505 and data received or transmitted by radios 415 and 420. Radios 1515 and 1520 can communicate with other electronic devices over a wireless network (e.g., WLAN) using multiple spatial streams (e.g., multiple antennas) and typically operates according to IEEE standards (e.g., IEEE 802.11ax, IEEE 802.1lay, IEEE 802.11be, etc.). Radios 1515 and 1520 can perform multi-link operations, and may operate over an NSTR pair of links. Wireless device 1500 can including more than two radios, according to embodiments. The radios (e.g., radios 1515 and 1520) can be configured to transmit and/or receive data using a number of different spatial streams based on device capabilities. The wireless device 1500 is operable to perform error recovery operations, including backoff procedures, PIFS recovery, and retransmission, and can end a TXOP, continue a TXOP, or acquire a new TXOP as part of the error recovery to advantageously avoid IDC.

Embodiments of the present invention are thus described. While the present invention has been described in particular embodiments, it should be appreciated that the present invention should not be construed as limited by such embodiments, but rather construed according to the following claims.

What is claimed is:

1. A method of wireless data exchange in a wireless network, the method comprising:
transmitting a first physical layer protocol data unit (PPDU) on a first wireless link during a first transmission opportunity (TXOP) and a second PPDU on a second wireless link during a second TXOP;
detecting a transmission failure on the first wireless link; and
terminating the second TXOP in response to the detecting the transmission failure on the first wireless link.

2. The method of claim 1, further comprising terminating the TXOP on the first wireless link responsive to the determining the transmission failure on the first wireless link without using priority interframe space (PIFS) channel access.

3. The method of claim 1, further comprising, responsive to the detecting the transmission failure:
performing a first backoff procedure on the first wireless link; and
performing a second backoff procedure on the second wireless link using contention parameters of a prior backoff procedure performed on the second wireless link.

4. The method of claim 1, further comprising receiving a first acknowledgement on the second wireless link, and wherein said detecting comprises determining that a block acknowledgement was not received on the first wireless link.

5. The method of claim 4, further comprising setting to zero a transmit network allocation vector (TXNAV) timer for the TXOP associated with the second wireless link.

6. The method of claim 3, wherein the first PPDU and the second PPDU comprise initial frame exchanges of the first TXOP and the second TXOP respectively.

7. The method of claim 1, wherein the second wireless link is configured to initiate a PPDU transmission by an MLD as a TXOP holder only when performing another PPDU transmission by the MLD as a TXOP holder substantially contemporaneously on the first wireless link.

8. The method of claim 1, wherein the first PPDU and the second PPDU comprise non-initial frame exchanges of the corresponding TXOP.

9. The method of claim 1, further comprising receiving an acknowledgment responsive to the transmitting the second PPDU on the second wireless link.

10. The method of claim 9, further comprising terminating the second TXOP after the receiving the acknowledgment on the second wireless link responsive to detecting the failure of the first PPDU on the first wireless link.

11. A method of wireless data transmission in a wireless network, the method comprising:
transmitting a first non-initial physical layer protocol data unit (PPDU) over a first wireless link and transmitting a second non-initial PPDU over a second wireless link;
determining that the transmitting a first non-initial PPDU over the first wireless link comprises a transmission failure;
receiving an acknowledgement responsive to the transmitting the second non-initial PPDU over the second wireless link;
transmitting a third non-initial PPDU on the second wireless link subsequent to the receiving; and
transmitting a fourth non-initial PPDU over the first wireless substantially contemporaneously with the transmitting the third non-initial PPDU.

12. The method of claim 11, further comprising transmitting the fourth non-initial PPDU on the first wireless link is subsequent to a backoff procedure responsive to the determining.

13. The method of claim 11, wherein the transmitting the fourth non-initial PPDU over the first wireless link is subsequent to a PIFS idle period in response to a decoding error of the acknowledgement in response to the first non-initial PPDU.

14. A method of wireless data exchange in a wireless network, the method comprising:
transmitting a first physical layer protocol data unit (PPDU) over a first wireless link within a first TXOP and a second PPDU over a second wireless link within a second TXOP;
determining that the transmitting the second PPDU over the second wireless link comprises a transmission error;
receiving an acknowledgement on the first wireless link responsive to the transmitting the first PPDU over a first wireless link within the first TXOP; and
transmitting another PPDU within the first TXOP and subsequent to the determining.

15. The method of claim 14, further comprising terminating the second TXOP on the second wireless link responsive to the determining.

16. The method of claim 14, further comprising acquiring a new TXOP on the second wireless link within the remaining duration of the first TXOP on the first wireless link responsive to the determining.

17. The method of claim 14, further comprising:
performing a backoff procedure on the second wireless link; and
transmitting a third PPDU on the second wireless link if the medium is idle subsequent to the performing the backoff procedure and subsequent to the receiving the most recent acknowledgment on the first wireless link.

18. The method of claim 14, further comprising performing error recovery on the second wireless link.

19. The method of claim 18, wherein the performing error recovery on the second wireless link comprises performing a backoff procedure to gain priority the access to the medium without using priority interframe space (PIFS) channel access on the second wireless link.

20. The method of claim 14, further comprising transmitting a third PPDU on the first wireless link and a fourth PPDU on the second wireless link substantially contemporaneously with performing a backoff procedure on the second wireless link.
